(19) United States
(12) Patent Application Publication
(10) Pub. No.: US 2002/0106606 A1
(43) Pub. Date: Aug. 8, 2002

(54) Easy access dental field operating and treatment system having over-the-patient delivery

(76) Inventor: Steven L. Eikenberg, Pleasant Prairie, WI (US)

Correspondence Address: SEED INTELLECTUAL PROPERTY LAW GROUP LLC, SUITE 6300, 701 FIFTH AVENUE, SEATTLE, WA, 98104-7092, US

(21) Appl. No.: 09/828,601

(22) Filed: Apr. 6, 2001

Related U.S. Application Data
(60) Provisional application No. 60/262,115, filed on Jan. 16, 2001.

(51) Int. Cl. A61C 13/38

(52) U.S. Cl. 433/77; 433/79; 312/209

(57) ABSTRACT

A dental treatment system which can include at least one dental bracket table; at least one portable base unit; and at least one suspension device coupled between the at least one dental bracket table and the at least one portable base unit, the at least one suspension device structured to allow a dental patient chair to be positioned substantially below the at least one dental bracket table. A dental treatment system which can include a portable enclosure structured to support at least one dental operatory component, the portable enclosure having at least one quick-release access panel. A method which can include coupling a suspension device between at least one dental bracket table and at least one portable base unit, the suspension device structured to allow a dental patient chair to be positioned substantially below the at least one dental bracket table.

### CROSS-REFERENCE(S) TO RELATED APPLICATION(S)

This patent application hereby incorporates by reference in its entirety pending Provisional Patent Application entitled Dental Field Operating and Treatment System, Over-The-Patient Delivery System, Application No. 60/262,115, naming Steven L. Eikenberg as inventor, filed via Express Mail on Jan. 16, 2001, and also claims the benefit of this Provisional Patent Application No. 60/262,115 under the auspices of 35 U.S.C. 119(e).

### FIELD OF THE INVENTION

The present application relates, in general, to portable dental treatment systems.

### BACKGOUND OF THE INVENTION

Dental treatment systems are systems which facilitate the delivery of dental services to patients. Portable dental treatment systems are dental treatment systems which have been designed such that they can be compacted and bundled so that a relatively fit person (e.g., a man or a woman) can physically carry the portable dental system.

There are many environments in which portable dental systems are particularly useful. One environment in which portable dental systems are particularly useful is the military environment, in which the portable dental systems are used to provide patient care to military service members in a field operating environment (e.g., soldiers encamped in a jungle, or airmen resident at a temporary airfield). Another environment in which portable dental systems prove particularly useful is the environment of an under-industrialized country (e.g., providing patient care to villagers which may not have sufficient power and/or sewer facilities sufficient to support and maintain fixed dental treatment systems). Yet another environment where portable dental systems prove to be particularly useful is the environment of in-home delivery of dental services (e.g., providing dental services to elderly and/or physically incapacitated patients whose physical impairments make it impracticable for such patients to travel to a dental office for dental services).

### SUMMARY OF THE INVENTION

In one embodiment, a dental treatment system can include but is not limited to at least one dental bracket table; at least one portable base unit; and at least one suspension device coupled between the at least one dental bracket table and the at least one portable base unit, the at least one suspension device structured to allow a dental patient chair to be positioned substantially below the at least one dental bracket table. In one embodiment, a dental treatment system can include but is not limited to a portable enclosure structured to support at least one dental operatory component, the portable enclosure having at least one quick-release access panel. In one embodiment, a method can include but is not limited to coupling a suspension device between at least one dental bracket table and at least one portable base unit, the suspension device structured to allow a dental patient chair to be positioned substantially below the at least one dental bracket table.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of this patent application will become apparent in the non-limiting detailed description set forth below.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1A shows a perspective view of portable dental treatment system 100 which provides for over-the-patient delivery of dental services.

FIG. 1B shows a second perspective view of portable dental treatment system 100.

FIG. 2 shows a dental bracket table 104 positioned such that dental bracket table 104 is suspended over dental patient chair 250 upon which is shown dental patient 252, whereby over-the-patient delivery of dental services is achieved.

FIGS. 3A-3C show various embodiments of suspension device 114.

FIG. 4A shows a perspective view of portable base unit 102 in an “open” position.

FIGS. 5A-5F show several close-up views of quick-release latch 500 both in isolation and while being manipulated to allow quick release of quick-release-access-panel 404.

The use of the same reference symbols in different drawings generally indicates similar or identical items.

### DETAILED DESCRIPTION OF THE PREFERRED EMBODIMENT

While the preferred embodiment of the invention has been illustrated and described, it will be appreciated that various changes can be made therein without departing from the spirit and scope of the invention.

### I. Portable Dental Treatment System Providing Over-the-Patient Delivery of Dental Services

It has been discovered by the inventor named herein (the inventor) that existing portable dental treatment systems place undue physical strain upon the ‘providers of dental services (e.g., dental surgeons and/or dental technicians). In particular, it has been discovered by the inventor that existing portable dental treatment systems tend to provide delivery of dental services in a manner substantially different than the manner in which dental services are ordinarily provided in permanent (e.g., non-portable) dental operatories.

In permanent dental operatories, dental services are ordinarily provided to patients via what is known in the art as “over-the-patient” mode. In contrast, in virtually all related-art portable dental treatment systems, dental services are generally provided in what will be referred to herein as “side-of-the-patient” mode. That is, rather than the dental treatment system suspending dental instruments such that a dental patient chair (and hence a patient) can be positioned substantially below the dental instruments, in related-art portable dental treatment systems, the dental instruments are often positioned in such a way that the instruments are to the side of the dental patient chair (and hence the dental patient).

Dental surgery, even under the best of working conditions, is physically fatiguing in that it requires both physical strength and manual dexterity in order to provide efficient and safe dental treatment to a dental patient (e.g., having the physical strength to remove a temporary dental crown held in place with temporary dental cement, and the manual dexterity to remove the temporary dental crown without damaging adjacent teeth). Insofar as both physical strength and manual dexterity tend to degrade with physical fatigue, permanent dental operatories are designed such that dental services can be provided with a minimal of physical strain on dental surgeons and/or the dental technicians assisting dental surgeons. One aspect of such design of permanent dental operatories is over-the-patient delivery, which has been found empirically to minimize physical fatigue and strain on both dental surgeons and/or dental technicians assisting dental surgeons. The inventor has recognized that insofar as the working conditions in a portable dental operating room environment tend to be significantly degraded relative to a permanent dental operating room environment, it would be advantageous to have a portable dental treatment system which provides over-the-patient delivery of dental services in a fashion analogous to that utilized in permanent, or fixed, dental operating room environments.

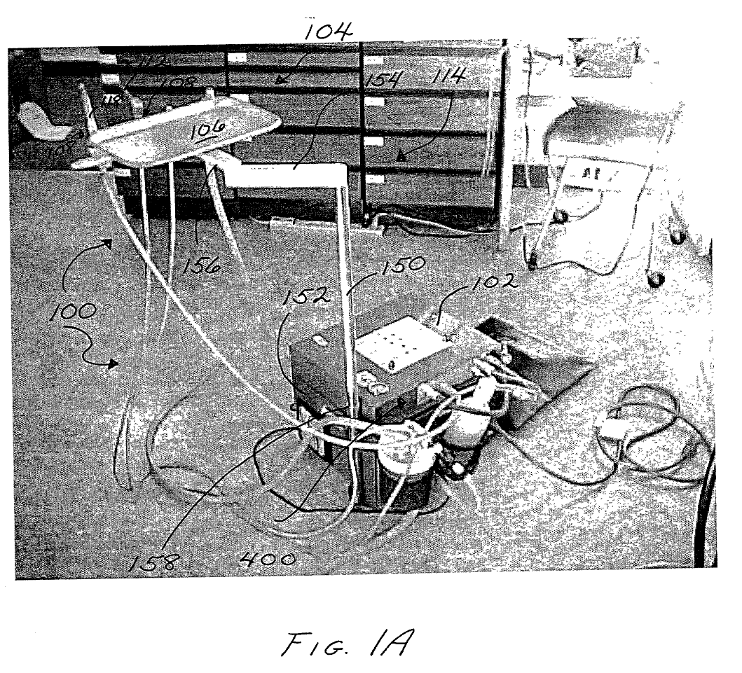

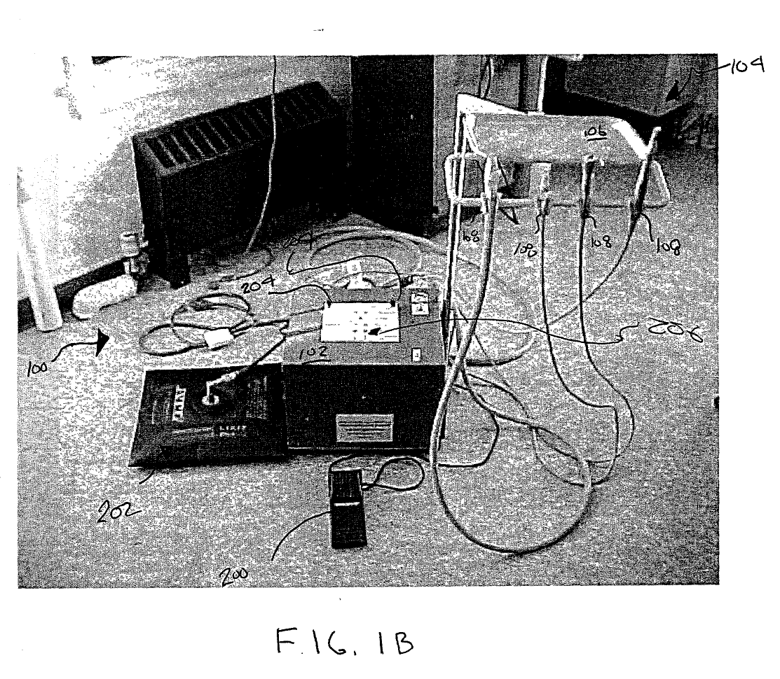

With reference now to FIG. 1A, shown is a perspective view of portable dental treatment system 100 which provides for over-the-patient delivery of dental services. Depicted is portable base unit 102 (in one implementation, portable base unit 102 houses a device for at least partially driving a dental operatory, such as an air compressor, or a suction pump, or an electric motor, etc.).

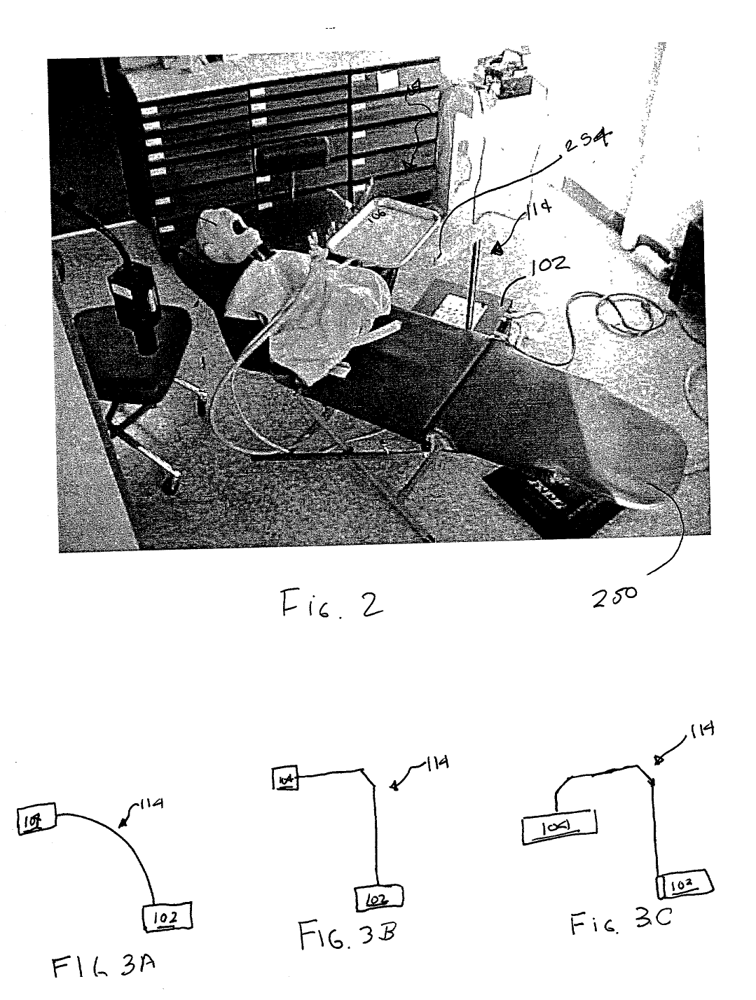

Illustrated is dental bracket table 104 (further illustrated is that dental bracket table 104 can include but is not limited to dental tray 106 and dental hand piece holders 108 (which are somewhat obscured by bracket table 106, but which are shaped such that they can hold dental instruments such as dental drill 110 or dental rinse instrument 112). Shown is suspension device 114 coupled between dental bracket table 104 and portable base unit 102, where suspension device 114 is structured to allow a dental patient chair to be positioned substantially below dental bracket table 104 (e.g., such as is depicted in FIG. 2).

Referring now to FIG. 1B, shown is a second perspective view of portable dental treatment system 100. Illustrated, in an unobstructed view, are dental hand piece holders 108. Shown is foot-pedal switch 200 which can be utilized by a dental surgeon to control various dental instruments via mechanical and/or electrical switches supported by portable base unit 102. Also depicted is pneumatic reservoir 202 which contains compressed air generated by an air compressor (not shown) internal to and supported by portable base unit 102. Also shown are mechanical switches 204 and electrical switches 206 which are supported by portable base unit 102.

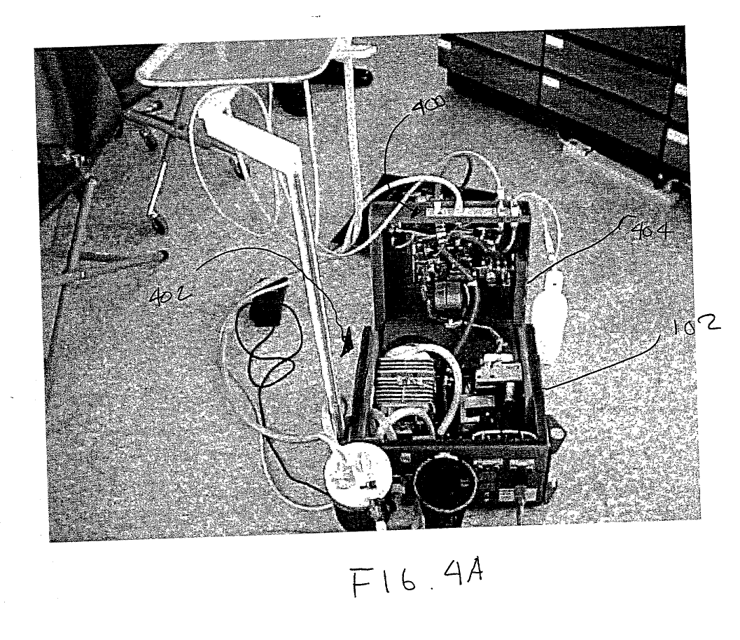

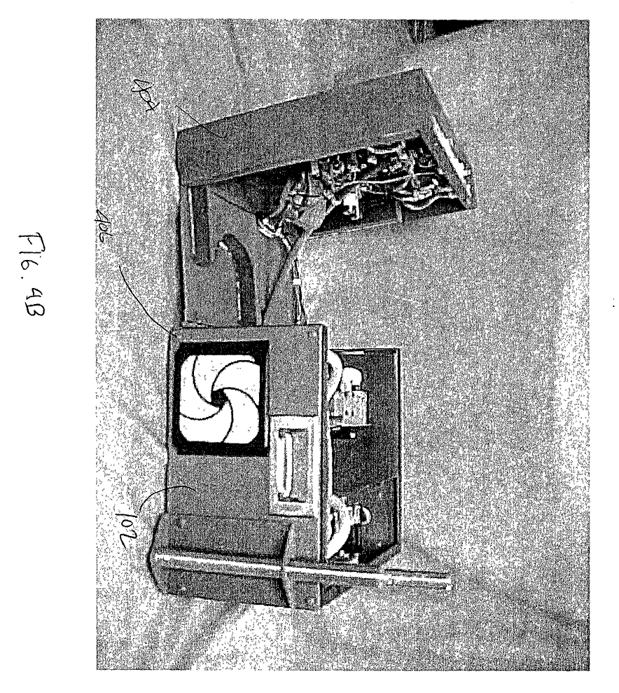

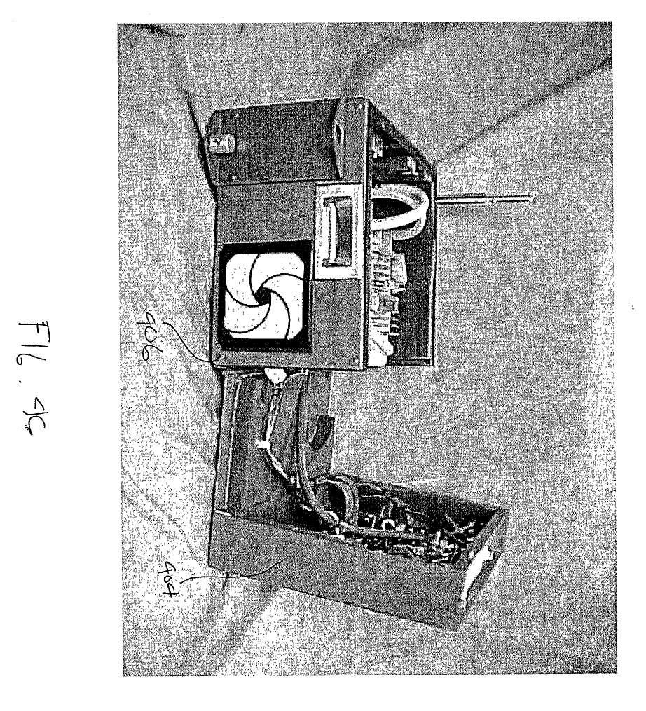

With reference now to FIG. 2, shown is dental bracket table 104 positioned such that dental bracket table 104 is suspended over dental patient chair 250 upon which is shown dental patient 252, whereby over-the-patient delivery of dental services is achieved. Continuing to refer to FIG. 2, it can be seen that over-the-patient delivery of dental services is achieved by virtue of the fact that suspension device 114 is formed such that dental bracket table 104 can be positioned over patient 252. Although suspension device 114 is shown in FIGS. 1A, 1B, and 2 as having a 90° bend whereby dental bracket table 104 can be positioned above dental patient chair 250, those skilled in the art will appreciate that various other forms can give the same result, such as the various embodiments of suspension device 114 illustrated in FIGS. 3A-3C.

Referring now to FIGS. 3A-3C, shown are various embodiments of suspension device 114. Referring now to FIG. 3A, depicted is an embodiment of suspension device 114 which uses a gentle curve rather than the sharp bend of the embodiment of dental device 114 of FIG. 2. Referring now to FIG. 3B, shown is an embodiment of suspension device 114 which uses a series of angular bends to achieve the result such that dental bracket table 104 may be positioned to provide over-the-patient delivery of dental services. With reference now to FIG. 3C, shown is yet another embodiment of suspension device 114 which uses yet more additional angular bends such that dental bracket table 104 can be positioned sufficient to provide over-the-patient delivery of dental services. Notice that FIGS. 3A-3C all show different manners and locations by which suspension device 114 can be attached to portable base unit 102. That is, the affixment of suspension device 114 need not be limited to that position shown in FIGS. 1A, 1B, and 2. Furthermore, FIGS. 3A-3C are all intended to convey that suspension device 114 is either affixed to portable base unit 102, or constructed such that dental bracket table 104 may be pivoted, or moved, into and out of the position above a dental patient chair (e.g., dental patient chair 250) thereby allowing easy ingress and egress to the couch by a dental patient. In addition, although not explicitly shown, dental bracket table 104 can have proximate thereto an additional pivot point analogous to pivot point 254 described in relation to FIG. 2.

With reference now again to FIG. 1A, shown is that in the embodiment of suspension device 114 shown in FIG. 1A, suspension device 114 includes first member 150 operably coupled with side 152 of portable base unit 102 and second member 154 illustrated as at least partially transverse to first member 150, where second member 154 has a first end operably coupled with dental bracket table 104 and a second end operably coupled with first member 150. In one embodiment, the operable coupling of second member 154 and first member 150 is such that the operable coupling allows pivoting about the axis of first member 150. (Although second member 154 has been shown and described herein as pivotably attached to first member 150, in another contemplated embodiment second member 154 is integral with first member 150, such as one continuous piece of molded plastic.) Furthermore, in the embodiment depicted in FIG. 1A, second member 154 is operably coupled with dental bracket table 104 via extension member 156 which is operably coupled with second member 154. In the embodiment shown in FIG. 1A, the operable coupling between extension member 156 and second member 154 is such that extension member 156, and hence bracket table 104, can pivot about an axis parallel to the axis of first member 150. (As described, dental bracket table 104 is operably coupled to second member 154 via extension member 156. Those skilled in the art will recognize that the pivotable connection described in relation to extension member 156 is illustrative of the fact that second member 154 is rotatably attached to dental bracket table 104, and hence an alternate embodiment would be dental bracket table 104 directly rotatably attached to second member 154.)

Continuing to refer to FIG. 1A, in the embodiment depicted in FIG. 1A, first member 150 is illustrated as rotatably attached to side 152 of portable base unit 102. In the embodiment shown, such rotatable attachment is accomplished via sleeve bracket 158 which is affixed to side 152 and is of size sufficient to accept first member 150 into sleeve bracket 158 such that first member 150 is held in a relatively vertical position but in a fashion such that first member 150 can rotate about its vertical axis within the confines of sleeve bracket 158. Those skilled in the art with recognize that alternate embodiments of sleeve bracket 158 are possible, such as will be shown and described below.

While the implementations described herein are believed by the inventor to be the best implementations, other implementations have been contemplated, such as the implementations described and depicted in the pending Provisional Patent Application entitled Dental Field Operating and Treatment System, Over-The-Patient Delivery System, naming Steven L. Eikenberg as inventor, Application No. 60/262,115, filed via Express Mail on Jan. 16, 2001, the contents of which are hereby incorporated by reference in their entirety.

Those having ordinary skill in the art will recognize that the discussion of the devices as set forth previously is representative of a method which can include but is not limited to coupling a suspension device (e.g., suspension device 114) between at least one dental bracket table (e.g., dental bracket table 104) and at least one portable base unit (e.g., portable base unit 102), where the suspension device is structured to allow a dental patient chair to be positioned substantially below the at least one dental bracket table. As has been described, the at least one dental bracket table can include but is not limited to at least one bracket tray (e.g., bracket tray 106), or at least one dental hand piece holder (e.g., dental hand piece holders 108). Also as has been discussed, the at least one portable base unit referred to in the method typically contains a device for at least partially driving a dental operatory, where the device for at least partially driving the dental operatory can include but is not limited to an air compressor, a suction pump, or an electric motor; as used in the above referenced system and in the currently referenced method, the devices for partially driving a dental operatory can provide the function of counter-balancing the dental bracket table (e.g., dental bracket table 104) such that dental surgeons and/or dental technicians have a secure and steady platform from which to provide dental services in an over-the-patient mode. Also as described above, the method step of coupling a suspension device can include operably coupling a first member (e.g., first member 150) with a side of the at least one portable base unit (e.g., side 152 of portable base unit 102), and operably coupling a second member (e.g., second member 154) substantially transverse to the first member such that the second member has a first end operably coupled with the at least one dental bracket table and has a second end operably coupled with the first member. However, as set forth above and as will be recognized by those having ordinary skill in the art, other couplings between the at least one dental bracket table and at least one portable base unit are contemplated, such as those shown in FIGS. 3A-C.

### II. Portable Dental Treatment System Providing Easy Access to Components

In addition to the problems of the related art cited above, the inventor has discovered that there are yet more deficiencies in related-art portable dental treatment systems. One such deficiency arises from the fact that related-art portable dental treatment systems do not allow for easy access to or maintenance of dental operatory components internal to and supported by portable base unit 102. The inventor has determined that this is a particularly significant limitation of related-art systems, given the fact that portable dental treatment systems need to be easily and quickly repaired in a field environment.

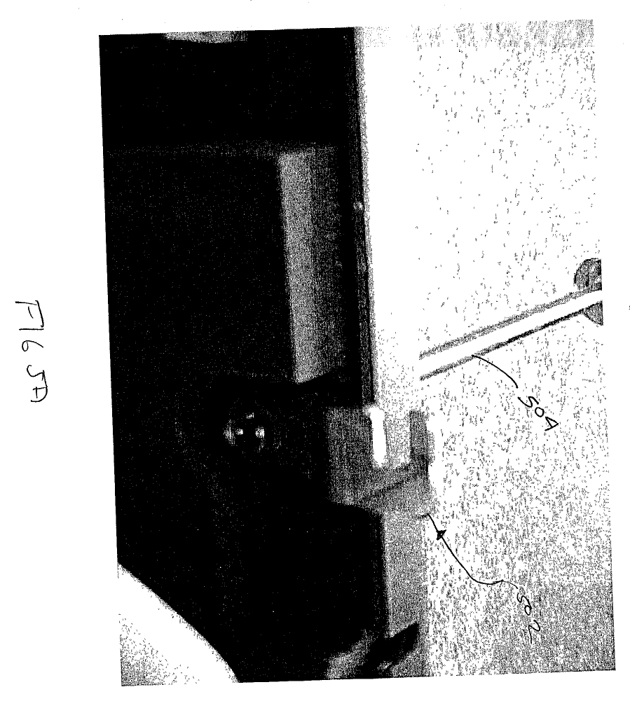

Referring now to FIG. 4A, shown is a perspective view of portable base unit 102 in an “open” position. The perspective view shown in FIG. 4 is in a similar perspective to the view shown in FIG. 1A. As an aid to orienting the reader, notice that the dental instrument connections 400 shown in FIG. 4 are the same dental instrument connections 400 shown in FIG. 1A. Depicted internal to and supported by portable base unit 102 are dental operatory components 402, which consist of an electric motor, an air compressor, various intermediary electronic circuits (e.g., a microprocessor and memory), as well as various electronic and pneumatic relays.

Depicted is quick-release-access-panel 404. In the embodiment shown, quick-release-access-panel 404 is rotatable about a pivotable connection 406 as shown in FIGS. 4B and 4C, which respectively show alternate perspective views of pivotable connection 406.

While the implementation shown herein constitutes the best implementation contemplated by the inventor, other implementations of quick-release-access-panel 404 have been contemplated. For example, the alternate implementation shown on pages E45 and E46 of pending Provisional Patent Application entitled Dental Field Operating and Treatment System, Over-The-Patient Delivery System, Application No. 60/262,115, naming Steven L. Eikenberg as inventor, filed via Express Mail on Jan. 16, 2001 the contents of which have been herein incorporated by reference in their entirety. Those skilled in the art will recognize that other embodiments are contemplated under the spirit of the teaching herein, such as having a quick-release slidable subpanel, such subpanel being hinged in a particular spot (e.g., the middle of the subpanel), such that the subpanel need not be rotated to allow quick access to the interior of portable base unit 102.

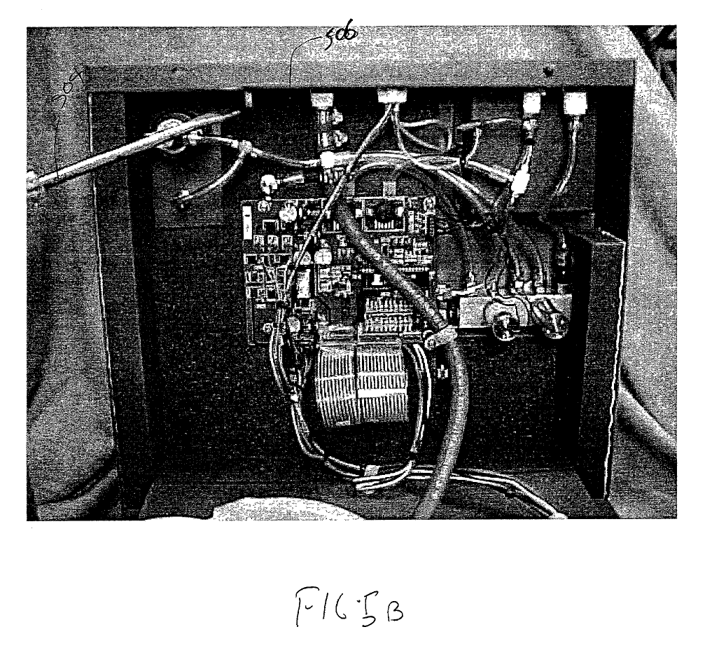

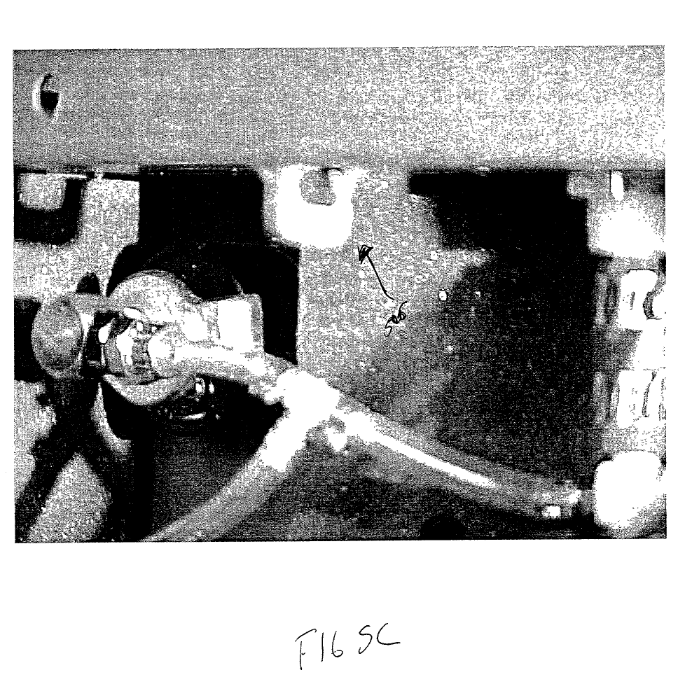

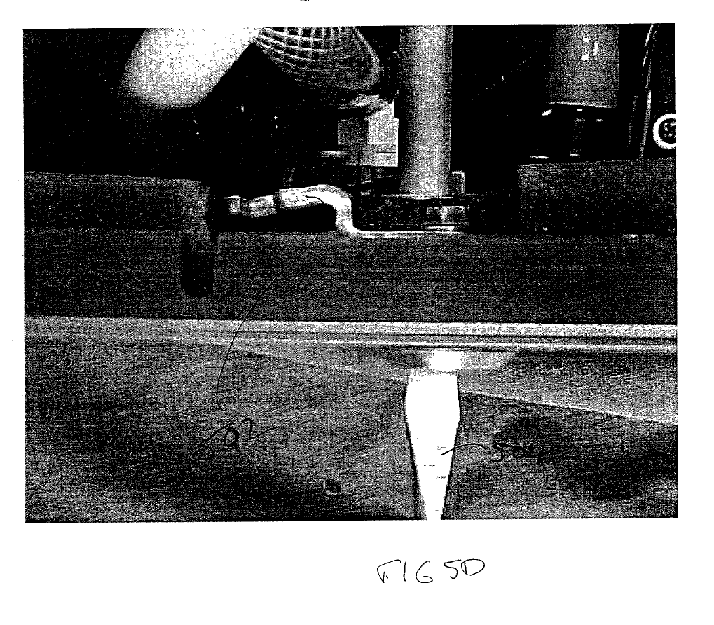

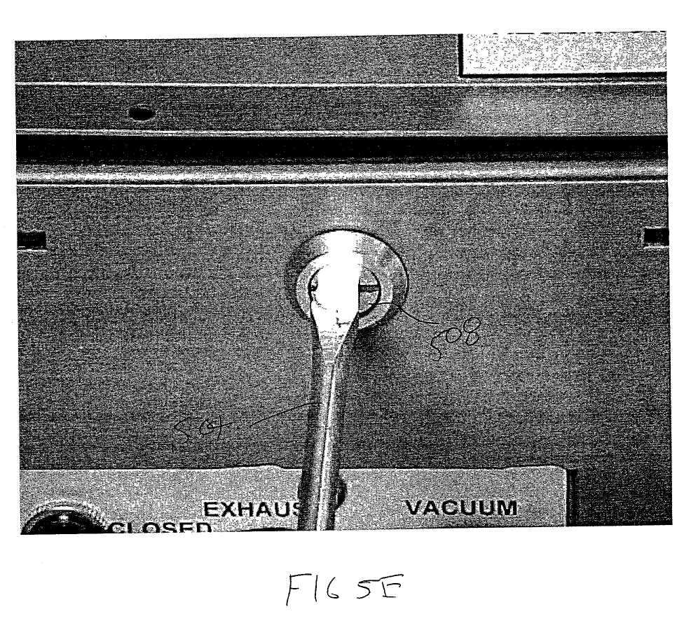

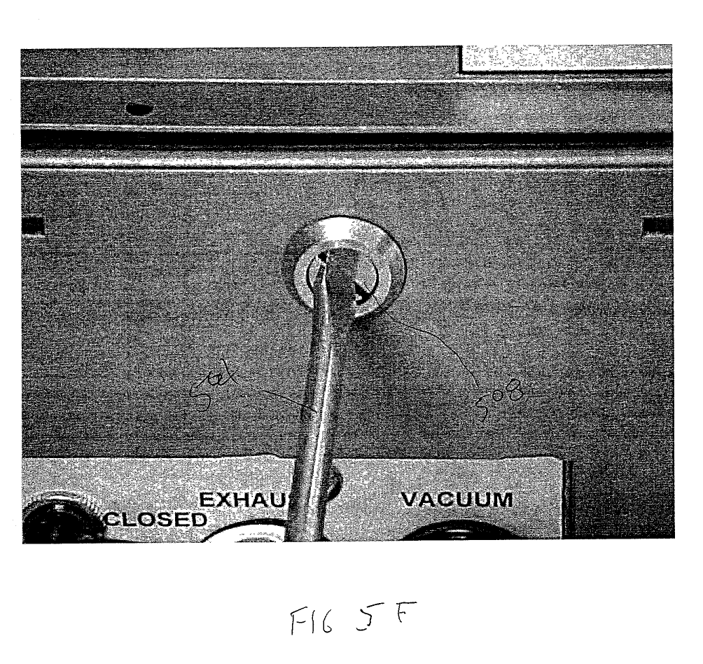

Referring now to FIGS. 5A-5F, shown are several close-up views of quick-release latch 500 both in isolation and while being manipulated to allow quick release of quick-release-access-panel 404. FIG. 5A depicts a perspective view of rotatable hook 502 of quick-release latch 500, which in one implementation is rotated via use of a slot head screw (e.g., slot head screw 508 in FIGS. 5E-F), which can be turned via flat-head screwdriver 504. FIG. 5B illustrates a plan view of u-shaped catch 506 of quick-release latch 500, which in FIG. 5B is being pointed at by flat-head screwdriver 504 for emphasis. FIG. 5C illustrates a perspective view of u-shaped catch 506 of quick-release latch 500. FIG. 5D depicts a top-plan view of rotatable hook 502 of quick-release latch 500, which in one implementation is rotated via use of a slot head screw, which is shown in FIG. 5D as being turned via flat-head screwdriver 504. FIGS. 5E-F illustrate alternate perspective views of slot head screw 508, which in one implementation is used to actuate quick-release latch 500, wherein the alternate perspective views show slot head screw 508 in various angles of rotation induced by flat-head screwdriver 504. Although quick-release latch 500 is shown as a slot-driven latch, those having ordinary skill in the art will recognize that quick-release latch 500 is exemplary of other types of quick-release latches including but not limited to other mechanical latches, electrical latches, or electromechanical latches, where the “quick release” function of such latches can be provided by, for example, a mechanical catch, an electrical keypad, or a combination release which may be either mechanical or electrical in nature.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that if a specific number of an introduced claim element is intended, such an intent will be explicitly recited in the claim, and in the absence of such recitation no such intent is present. For example, as an aid to understanding, the following appended claims may contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use of definite articles used to introduce claim elements. In addition, even if a specific number of an introduced claim element is explicitly recited, those skilled in the art will recognize that such recitation should typically be interpreted to mean at least the recited number (e.g., the bare recitation of “two elements,” without other modifiers, typically means at least two elements, or two or more elements).

The embodiments of the invention in which an exclusive property or privilege is claimed are defined as follows:

1. A dental treatment system comprising:
at least one dental bracket table;
at least one portable base unit; and
at least one suspension device coupled between said at least one dental bracket table and said at least one portable base unit, said at least one suspension device structured to allow a dental patient chair to be positioned substantially below said at least one dental bracket table.

2. The dental treatment system of claim 1, wherein said at least one dental bracket table comprises:
a bracket tray or a dental hand piece holder.

3. The dental treatment system of claim 1, wherein said at least one portable base unit comprises:
said at least one portable base unit having a device for at least partially driving a dental operatory, the device for at least partially driving including but not limited to an air compressor, a suction pump, or an electric motor.

4. The dental treatment system of claim 1, wherein said at least one portable base unit comprises:
an enclosure structured to support at least one dental operatory component selected from a group of dental operatory components including but not limited to an air compressor, a suction pump, an electric motor, a control knob, an electrical switch, and a mechanical switch.

5. The dental treatment system of claim 1, wherein said at least one suspension device structured to allow a dental patient chair to be positioned substantially below said at least one dental bracket table comprises:
a curved member operably coupled between a side of said at least one portable base unit and said at least one dental bracket table.

6. The dental treatment system of claim 1, wherein said at least one suspension device structured to allow a dental patient chair to be positioned substantially below said at least one dental bracket table comprises:
a first member operably coupled with a side of said at least one portable base unit; and
a second member at least partially transverse to said first member, said second member having a first end operably coupled with said at least one dental bracket table and a second end operably coupled with said first member.

7. The dental treatment system of claim 6, wherein said first member operably coupled with a side of said at least one portable base unit comprises:
said first member rotatably attached to the side of the at least one portable base unit.

8. The dental treatment system of claim 7, wherein said first member rotatably attached to the side of the at least one portable base unit comprises:
a mounting bracket affixed to the side of said at least one portable base unit, said mounting bracket having a circular opening; and
said first member inserted in said circular opening.

9. The dental treatment system of claim 6, wherein said second member having a first end operably coupled with said at least one dental bracket table and a second end operably coupled with said first member comprises:
said second member integrally molded with said first member.

10. The dental treatment system of claim 6, wherein said second member having a first end operably coupled with said at least one dental bracket table and a second end operably coupled with said first member comprises:
said second member rotatably attached to said at least one dental bracket table.

11. A dental treatment system comprising:
a portable enclosure structured to support at least one dental operatory component, said portable enclosure having at least one quick-release access panel.

12. The dental treatment system of claim 11, where the at least one quick-release-access-panel comprises:
at least one slidable sub-panel.

13. The dental treatment system of claim 11, where the at least one quick-release-access-panel comprises:
at least one hinged sub-panel.

14. The dental treatment system of claim 11, where the at least one quick-release-access-panel comprises:
at least one slidable hinged sub-panel.

15. The dental treatment system of claim 11, where the at least one quick-release-access-panel comprises:
at least one manual-release latch.

16. The dental treatment system 15, wherein said at least one manual-release latch comprises:
a mechanical latch, or an electrical latch, or an electromechanical latch.

17. The dental treatment system 15, wherein said at least one manual-release latch comprises:
a key-release latch, a touchpad release latch, or a combination release latch.

18. A method comprising:
coupling a suspension device between at least one dental bracket table and at least one portable base unit, said suspension device structured to allow a dental patient chair to be positioned substantially below the at least one dental bracket table.

19. The method of claim 18, wherein said at least one dental bracket table comprises:
a bracket tray or a dental hand piece holder.

20. The method of claim 18, wherein said at least one portable base unit comprises:
said at least one portable base unit containing a device for at least partially driving a dental operatory, the device for at least partially driving including but not limited to an air compressor, a suction pump, or an electric motor.

21. The method of claim 18, wherein said coupling a suspension device between at least one dental bracket table and at least one portable base unit, said suspension device structured to allow a dental patient chair to be positioned substantially below the at least one dental bracket table comprises:
operably coupling a first member with a side of the at least one portable base unit; and
operably coupling a second member substantially transverse to said first member such that said second member has a first end operably coupled with said at least one dental bracket table and has a second end operably coupled with said first member.
